(19) United States
(12) Patent Application Publication
(10) Pub. No.: US 2010/0220880 A1
(43) Pub. Date: Sep. 2, 2010

(54) HEARING AID COMPRISING PARTS MADE OF ELECTRICALLY CONDUCTIVE AND SIMULTANEOUSLY SOUND-ABSORBENT MATERIAL

(75) Inventor: Thomas Weidner, Erlangen (DE)

Correspondence Address: LERNER GREENBERG STEMER LLP, P O BOX 2480, HOLLYWOOD, FL, 33022-2480, US

(73) Assignee: SIEMENS AUDIOLOGISCHE TECHNIK GMBH, Erlangen (DE)

(21) Appl. No.: 12/679,168

(22) PCT Filed: Aug. 28, 2008
(86) PCT No.: PCT/EP08/61271

§ 371 Date: Mar. 19, 2010

(30) Foreign Application Priority Data
Sep. 24, 2007 (DE) 10 2007 045 516.1

(51) Int. Cl. H04R 25/00

(52) U.S. Cl. 381/317; 381/322

(57) ABSTRACT

A hearing aid has parts made of electrically conductive and simultaneously sound-absorbent material. These parts are at the same time used as sound-absorbent elements of the design of the hearing aid, the housing thereof or the components thereof and as electrical contacts.

Hearing aid comprising parts made of electrically conductive and simultaneously sound-absorbent material

Due to new applications such as, for example, hearing aids with an external headset or hearing aids with a rechargeable energy store (e.g.) accumulator, the number of external electrical connections is rising. These external connections of hearing aids are often produced as externally accessible, electrical contacts made of gold-plated metal. Thus, the complexity and the costs of these hearing aids significantly increase with a growing number of connections. Examples are the numerous types of audio inputs, programming connections and charge contacts in commercially available hearing aids.

The present invention attempts to improve this situation. According to the invention, electrical contacts, made of electrically conductive and simultaneously sound-absorbent material without additional metal parts, are provided for this purpose on the external side of a hearing aid housing.

Thus, the invention results in a hearing aid with parts made of electrically conductive and simultaneously sound-absorbent material, which at the same time are used as sound-absorbent elements of the design of the hearing aid, the housing thereof or the components thereof and as electrical contacts.

According to an advantageous embodiment of the invention, the hearing aid is provided with parts made of electrically conductive and simultaneously elastic material, in particular with parts made of an elastic natural material or plastic, into which electrically conductive particles were admixed during the processing.

It is particularly advantageous if the hearing aid is equipped with parts made of electrically conductive and simultaneously sound-absorbent material, to which pigments, which contribute to the optical inconspicuousness of these parts in respect of their surroundings, were admixed during the processing. The term “sound-absorbent” should in this context be understood as an acoustically sealed connection, which predominantly is based on shock and/or vibration-inhibiting properties.

In the process, already existing parts of a hearing aid, which parts are accessible on the external side and previously had no electrical functionality, are preferably used in parallel as electrical contacts.

Furthermore, a hearing aid with parts made of electrically conductive and simultaneously sound-absorbent material, which serve as a support for components of the hearing aid, which should be acoustically shielded against sound transmission via these parts, is particularly advantageous. The transducer supports currently made of various rubber-like materials such as silicone and which currently mainly satisfy acoustic requirements—for example in respect of sound damping—should be mentioned on the one hand. In this context, transducers should mainly be understood as headsets or microphones.

In one of its embodiments, the present invention now provides for producing these supports—for example, transducer supports made of electrically conductive and simultaneously sound-absorbent material—from electrically conductive material (e.g. a conductive rubber) and thus providing an electrical contact on the external side of a hearing aid, which contact furthermore would not even be perceived as such and would therefore also constitute a cosmetically more pleasing option for an electrical contact. Combining these two properties of electrical conductivity and sound damping can be achieved, for example, by admixing conductive particles or by introducing metallic particles by vulcanization or by subsequent external metalizing, for example by evaporation.

Since the transducer housings themselves are often already electrically connected to the actual amplifier circuit (for example, the microphone housing is mainly at ground potential), it is possible to dispense with even the additional connection from the externally accessible contact to the printed circuit board. Since the metal housing of the transducer already lies electrically on the reference potential (“Ground” or GND) and the conductive elastic mass now also touches the housing, a conductive contact is already available on the external side, simply as a result of the visible mounting.

A further already existing component not previously used as an electrical contact is the so-called connecting piece. This usually comprises metal. In the case of so-called “behind-the-ear hearing aids”, the so-called tone hook is screwed or affixed on said connecting piece. Here, an embodiment of the invention provides for using this component as an electrical contact—for example, to external transducers or external switches.

The internal connection to the hearing aid amplifier can in turn be brought about by electrically conductive headset supports or, in this case, by directly connecting an electric line (e.g. soldering, welding, clamping, bonding . . . )

Thus, the present invention has a multiplicity of advantages.

Firstly, it is possible to use existing components as electrical contacts, which obtains a significant decrease in costs whilst at the same time reducing the complexity. Furthermore, a cosmetically more appealing contact design is made possible by inconspicuous (“invisible”) electrical contacts, or electrical contacts that are not perceived as such.

These measures of the invention or the advantageous developments thereof permit further circuit applications on the aid or signal transmission to external hearing aid components or external equipment. Moreover, additional automatic recognition circuits are made possible.

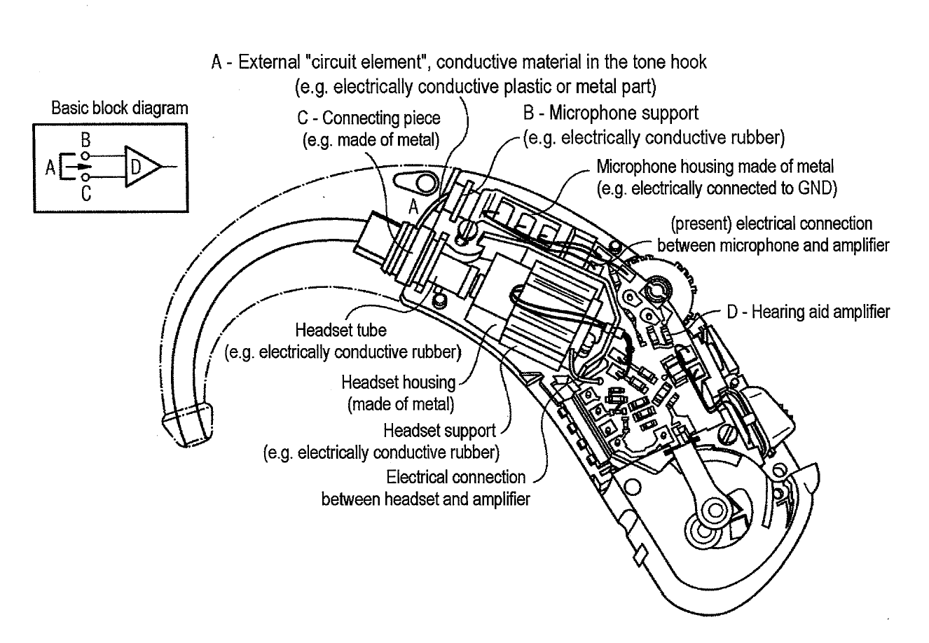

FIG. 1 shows a schematic view of a possible embodiment of the invention. As a result of the corresponding design of a hearing aid, it would be possible, for example, to recognize the presence of a particular tone hook automatically. In this case, the external “circuit element” (A) acts as an electrical contact between the conductive microphone support (B) and the metal connecting piece (C).

1-6. (canceled)

7. A hearing aid, comprising:
parts made of electrically conductive and simultaneously sound-absorbent material;
said parts being formed as sound-absorbent elements of a construction of the hearing aid, the housing thereof or the components thereof, and as electrical contacts.

8. The hearing aid according to claim 7, comprising parts made of electrically conductive and simultaneously elastic material.

9. The hearing aid according to claim 7, comprising parts made of an elastic natural material or plastic, into which electrically conductive particles were admixed during the processing.

10. The hearing aid according to claim 7, comprising parts made of electrically conductive and simultaneously sound-absorbent material having pigments admixed thereto during processing, for contributing to an optical inconspicuousness of said parts in respect of their surroundings.

11. The hearing aid according to claim 7, comprising parts made of electrically conductive and simultaneously sound-absorbent material, said parts serving as a bearing support for components of the hearing aid that should be acoustically shielded against sound transmission by way of said parts.

12. The hearing aid according to claim 11, comprising transducer supports made of electrically conductive and simultaneously sound-absorbent material.
